(19) United States
(12) Patent Application Publication
(10) Pub. No.: US 2015/0095214 A1
(43) Pub. Date: Apr. 2, 2015

(54) ELECTRONIC GIFTING PROCESS AND APPARATUS

(71) Applicants: Richard AHN, Los Angeles, CA (US); Nicholas AHN, Los Angeles, CA (US)

(72) Inventors: Richard AHN, Los Angeles, CA (US); Nicholas AHN, Los Angeles, CA (US)

(21) Appl. No.: 14/040,486

(22) Filed: Sep. 27, 2013

(51) Int. Cl. G06Q 20/22; G06Q 10/08

(52) U.S. Cl. CPC G06Q 20/227; G06Q 10/0833
USPC 705/39; 705/333

(57) ABSTRACT

A computer-implemented method of purchasing an item and transmitting a message to a recipient of the item is presented. The method entails receiving location data about where the item can be picked up, obtaining a recipient address, receiving personal content for the recipient, and combining the location data with the personal content to create an electronic data package. The personal content may include one or more of an image, a written message, an audio segment, and a video segment. The electronic data package is transmitted to the recipient address. Optionally, the data in the data package (other than the location data) may be customized such that it is disclosed to a recipient at a pre-specified physical location.

### FIELD OF INVENTION

This disclosure relates generally to electronically purchasing an item for someone other than the purchaser, and in particular to electronically purchasing an item for someone using location data.

### BACKGROUND

People today are becoming increasingly dependent on their mobile electronic devices to plan, organize, and execute daily tasks. Just a few decades ago, a desktop computer was the main electronic device that people relied on to exchange written messages, plan their lives on a calendar, and look up various information. However, people today are freed from their desktops and offices due to advances in mobile device technology and wireless connectivity. Naturally, much effort is directed at ways to build more functions into mobile devices. As a result, people today have numerous ways to communicate with each other from anywhere, take photographs, play music, watch movies, read books, draw, write, organize their lives, shop, etc. using their mobile devices.

Gift giving has been a part of human interaction throughout history and in many different parts of the world. Gift giving is a uniquely human form of communication, and people derive much joy and fulfillment giving and receiving gifts. Sometimes, gifts are for special occasions such as graduations, farewells, weddings or birthdays. At other times, however, gifts are given for no formal reason purely as a form of human expression or generosity. From the giver's perspective, one of the more enjoyable aspects of giving a gift is imagining how the recipient will feel upon receiving it (and hoping that it will be a positive reaction). From the recipient's end, one of the exciting aspects of receiving a gift is finding out what it is and who it is from, for example by unwrapping the gift.

Gift giving being such a natural part of people's lives, functions that are similar to gifting have been developed for mobile devices. For example, one can purchase an item using his mobile device and have it sent to a recipient's address. However, this type of transaction often takes away the human, personal and emotional dimension of a gift exchange. Furthermore, there is often some type of a mail or delivery service that is involved in getting the item to the recipient, and annoying and disappointing situations arise when the mail or delivery service fails to function as expected. A way of giving and receiving gifts by using a mobile electronic gadget while preserving the emotional and human elements that are involved a traditional, physical gift giving is desired.

### SUMMARY

In one aspect, the inventive concept pertains to a computer-implemented method of providing data via a mobile device. The method entails receiving a data package that includes location data and hidden data, tracking current location, and presenting the hidden data upon determining that the location data matches the current location.

In another aspect, the inventive concept pertains to a computer-implemented method of transmitting a message. The method entails receiving location data, obtaining a recipient address, receiving personal content that includes one or more of an image, a written message, an audio segment, and a video segment, combining the location data with the personal content to create an electronic data package, and transmitting the electronic data package to the recipient address. Optionally, some of the data other than the location data may be customized such that it is disclosed to a recipient at a physical location that matches the location data.

In another aspect, the inventive concept pertains to a non-transitory computer-readable storage medium storing executable computer program instructions for providing data via mobile device, wherein the computer program instructions comprise instructions to execute one or more of the above methods.

### BRIEF DESCRIPTION OF THE DRAWINGS

FIG. 1 is a high-level diagram of an example environment for implementing the electronic gifting process in accordance with the inventive concept.

FIG. 2 is a flowchart illustrating an electronic gifting process 50 in accordance with the inventive concept.

FIG. 3 is a flowchart depicting a gift retrieval process 80 in accordance with the inventive concept.

FIG. 4 depicts an example of a search screen that may be used to make an item selection.

FIG. 5 depicts an example of a map-based search page that may be used to make an item selection.

FIG. 6 depicts an example of a screen that may be shown in response to a purchaser's making an item selection.

FIG. 7 depicts an example of a payment interface that may be presented to a purchaser.

FIG. 8 depicts an example of a screen that may be presented to the purchaser to make a recipient selection.

FIG. 9 depicts an image that may be incorporated into the data package that is to be transmitted.

FIG. 10 depicts an example of a Gift Notice that may be presented to a recipient.

FIG. 11 depicts an example of a screen that may be presented to a recipient of a data package with hidden information.

FIG. 12 depicts an example of a screen that may be presented to a recipient of a data package where all information is disclosed.

FIG. 13 is a screen showing previously geo-tagged items.

### DETAILED DESCRIPTION

The process and system disclosed herein provides a way for someone to purchase an item for another person electronically without losing the enjoyable and emotional aspects of a traditional, non-electronic gift giving. Also, the gifting process disclosed herein may be used with services as well as products.

The figures and the following description describe certain embodiments by way of illustration. One skilled in the art will readily recognize that alternative embodiments of the apparatus and methods illustrated herein may be employed without departing from the principles described herein. Reference will be made in detail to several embodiments, examples of which are illustrated in the accompanying figures.

A method and system for electronically giving and receiving a gift is provided. Although the inventive concept is described in the context of gift giving and receiving, this is not a limitation on its potential application and the method and system disclosed herein may be used in various other contexts. The term “gifting” is broadly used throughout the disclosure to include any situation where the purchaser of an item is different from the immediate recipient of the item.

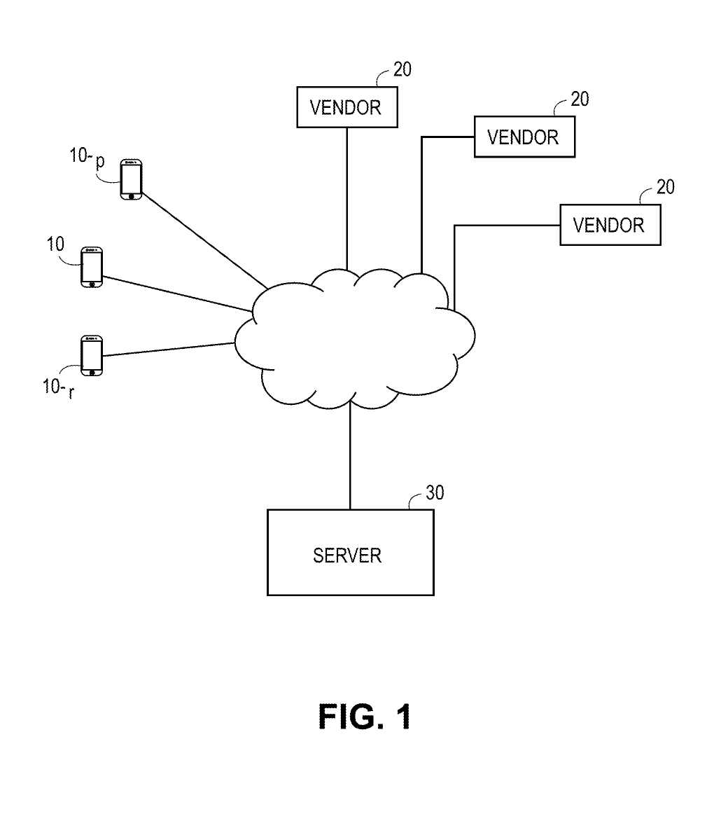

FIG. 1 is a high-level diagram of an example environment for implementing the electronic gifting process in accordance with the inventive concept. As shown, there are a plurality of mobile devices 10, a plurality of vendors 20, and a server 30 that are configured to communicate with one another via a network. One of the mobile devices 10 (e.g., mobile device 10-p) may be controlled by or in communication with a gift giver or a purchaser. One or more of the mobile devices 10 (e.g., mobile device 10-r) may be controlled by or in communication with a gift recipient. “Mobile device 10,” as used herein, includes mobile device 10-p and mobile device 10-r. Although much of the description is provided in the context of one purchaser (gift giver) and one recipient, this is for simplicity and clarity of explanation and not a limitation of the inventive concept. There may be multiple givers and/or multiple recipients. The vendors 20 may be stores, restaurants, distributors, etc. that provide the gifts to the recipients. The server 30 is a computing system that is associated with the gifting process.

The gifting application may be downloaded onto a mobile device 10, for example as a platform-specific or cross-platform application although this is not a limitation of the inventive concept. The mobile device 10 may be any portable electronic device that has a processor, memory, and network connection capability. For example, a mobile device 10 may be a smartphone, a tablet, a laptop, a personal digital assistant (PDA), among others. The mobile device 10 includes a location-determining capability, for example a GPS chip. The mobile device 10 may also incorporate various other functions for creating personal content to be included in the Gift Notice, which will be described in more detail below. Additional functions may include a camera, a way to record a drawing or a handwritten note, a way to record a voice message, a way to store and play snippets of music/video, sound effects, etc.

Additionally, the mobile device 10 includes geo-tagging capability. When the mobile unit 10 takes a picture with its camera, for example, the image may be geo-tagged so that the photograph is associated with metadata that identifies the geographical location where the photograph was taken. Conventional geo-tagging techniques may be used to either automatically geo-tag the photographs or present a geo-tag option to the user. Examples of geo-tag metadata include latitude and longitude coordinates, altitude, distance, orientation, and accuracy data. Geo-tag metadata may be associated with not just a photograph but any other data (e.g., name of a restaurant or store).

The server 30, which is a computing system, may store various information that is usable by the mobile devices 10. For example, the server 30 may store a list of vendors who have been tagged before or used before by the system. Each time a new item is geo-tagged by a purchaser, for example by the purchaser taking a photo of the vendor using the mobile device 10-p with the geo-tag function activated, the item and vendor are added to the server 30. Various other information may reside in the server 30, including but not limited to the popularity level of each item (which may be based on the number of times an item is geo-tagged and/or purchased), reviews for the item and/or the vendor, phone number and address, and contact name for each vendor, description of the vendor, etc. Names, images, and prices of the items offered by each vendor, store hours, and location data may also be stored. The information in the server 30 may be transmitted or downloaded to various mobile devices 10 as needed.

Each time a new item is purchased, another entry may be added to the server 30. In one embodiment, every item that is stored in the server 30 will have been geo-tagged by one of the mobile devices 10. Although an item usually has to be geo-tagged by a mobile device 10 at the physical location to initially be added to the server 30, a subsequent user can select the item with the location data without physically being at the location. Once an item is added to the server with the geo-tag location data associated with the vendor, it may simply be selected as a gift item by a purchaser who is not at the vendor site. The location data in the geo-tag will be associated with the vendor site even if a subsequent user selects the vendor from a list.

In some embodiments, a vendor who has at least one of its items geo-tagged and added to the server 30 is allowed to upload its menu. The entire menu will share the same geo-tag. The menu offers potential purchasers more options. In some embodiments, even vendors who were never geo-tagged may be able to register themselves with the server 30 and upload its menu.

The server 30 may also store information about mobile devices 10 that downloaded or used the gifting process. The information may include basic personal information that is associated with each mobile device 10, such as the user/owner's name, phone number, and a payment information such as a credit card, debit card, or bank routing number. The server 30 may also store historical data about each mobile device, such as which items have been tagged/purchased/received by each particular mobile device 10.

In addition, the server 30 may store information about recipients' mobile devices 10-r. A purchaser may add to the list of recipients by inputting an email address, phone number, etc. along with a name. If the recipient already downloaded the gift-giving application (i.e., s/he was a purchaser before), his/her information will already be in the server 30 from when the installation was done.

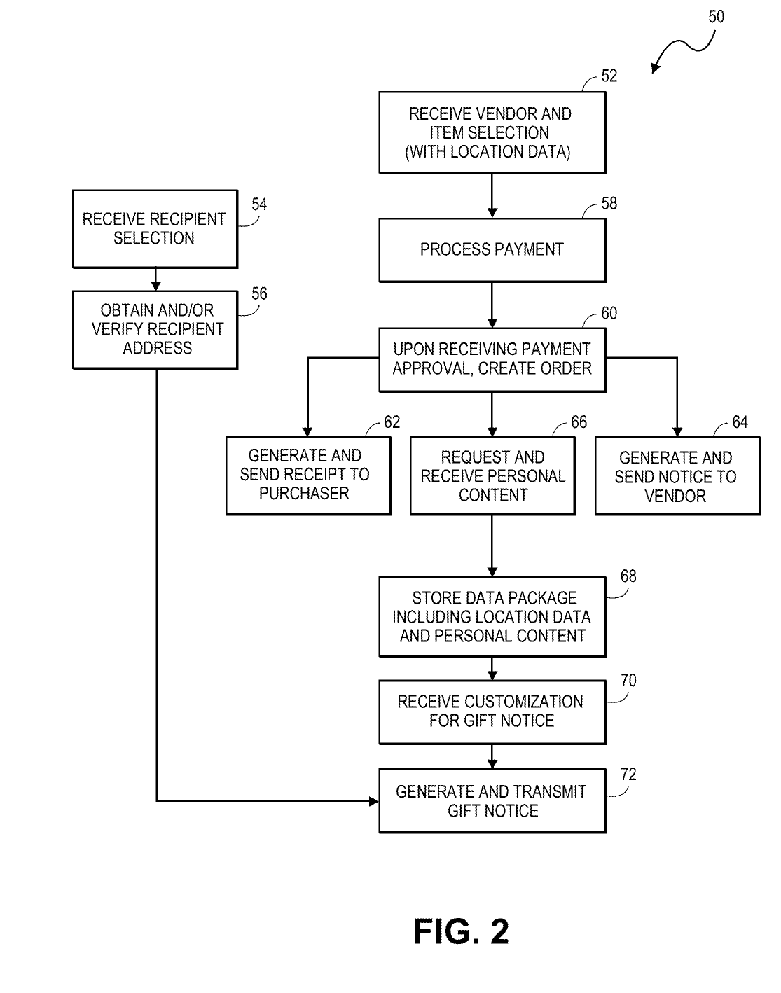

FIG. 2 is a flowchart illustrating an electronic gifting process 50 in accordance with the inventive concept. As shown, the gift giving process 50 begins with receiving input from a purchaser regarding what the gift item is and who it is for. In some cases, the item selection may be made by the user after a list of items are presented to the gift giver, either based on a user query (e.g., search word) or based on history of previous purchases. In some embodiments, the list of items may be based on a geographical limitation specified by the purchaser, such as a list of vendors that are within an x-mile radius from his/her current location. In yet another embodiment, the purchaser may be presented with preset categories such as “Recently Added,” “Most Popular,” “Deals & Coupons,” etc. Items that were previously purchased or geo-tagged by someone on a purchaser's Contacts list or Friends list may be highlighted.

A purchaser may geo-tag multiple items from a vendor location. By selecting an option such as “Previously Tagged items,” the user can retrieve information from the server 30 regarding previously geo-tagged items, perhaps indexed by vendors. If the purchaser wants to see a list of items that he himself previously geo-tagged, the data may be stored locally on his mobile device 10-p. This information may be retrieved in a list format showing previously tagged items, or in a map format such as the example shown in FIG. 13. Selecting one of the items on the list/map will reveal details about the item, such as price and vendor information. The purchaser may then proceed to select the item to be gifted.

The items may have specific vendors and their location data associated with them, such as the geo-tag coordinates and the address. The purchaser may further filter the list using criteria such as price range, geographic location, popularity, item type, etc. The gift giver selects an item (step 52) and a recipient (step 54). The recipient selection may be made from a preexisting list (e.g., a Contacts list, a friends list associated with a remote database) or may be manually input. Upon receiving the recipient, the recipient's contact information (e.g., email address or phone number) is obtained or verified (step 56) to make sure the data package can be sent.

The purchaser pays for the item (step 58). The payment does not have to be for the entire price, and an option will be presented to the gift giver to make a partial payment or a complete payment. Once the payment information is provided (e.g., a credit card number, a prepaid account, bank routing number, etc.) and the payment is verified, an order is created (step 60). A third party process and system may be involved in processing the payment.

When the payment is successfully processed and an order is created (step 60), a receipt may be generated and presented to the mobile device 10-p (step 62). The receipt, or another similar notice, may be generated and transmitted to the chosen vendor (step 64). The receipt may contain detailed information about the item, such as the vendor, expiration date of the gift, amount paid, recipient, etc.

The purchaser can personalize the gift ticket in a variety of ways by adding personal content. Such personal content may be requested (step 66), perhaps with a question such as “Would you like to add personal content to the gift?” Upon receiving “yes” as a reply, the process 50 may receive a photograph, a typed or handwritten message, a drawing, a video (including short segments of a movie or a home-made clip), music, sound effects, a downloaded image, etc. (step 66). This way, the process 50 allows the gift giver to create a personal presentation that accompanies the gift. The personal content that is received gets packaged with other data regarding the item, such as vendor location data, and stored as a data package (step 68). The data package may be stored in the server 30 in addition to locally on the mobile device 10.

An option is then presented to see if any customization is desired for the Gift Notice (step 70). The customization process allows the gift to be presented to the recipient in stages or layers. More specifically, the electronic gifting process 50 allows the purchaser to “hide” certain pieces of information that is in the data package such that it is presented to the recipient at a different time than the unhidden, plain data. Typically, the recipient first opens a Gift Notice and sees the plain (unhidden) data. The hidden data may be configured to be presented or revealed to the recipient at a different time (usually later), triggered by the physical location of the recipient's mobile device 10-r.

For example, let us suppose that the purchaser chose to hide what the item is during the customization process 70. Due to this customization, the Gift Notice that the recipient sees will not immediately show what the item is even though that data is part of the data package. Upon opening the Gift Notice, the recipient will only see that there is a mystery gift waiting for him/her at a certain location. To find out what the mystery item is, the recipient would have to physically go to the location in the Gift Notice. Upon the recipient's mobile data 10-r being in the proximity of the vendor location, the information that was hidden will be automatically disclosed. During the customization process 70, the purchaser may specify what constitutes a “location match” that would trigger the hidden portion of the data package to be disclosed. Depending on the situation, the purchaser may want the “location match” to happen when the recipient is within a few miles of the vendor location, few blocks of the vendor location, or exactly at the vendor location When the location match happens, all the data in the surprise package becomes disclosed. A Gift Notice is created using the customization data that is received in step 70, and transmitted to the recipient using the verified recipient address (step 72).

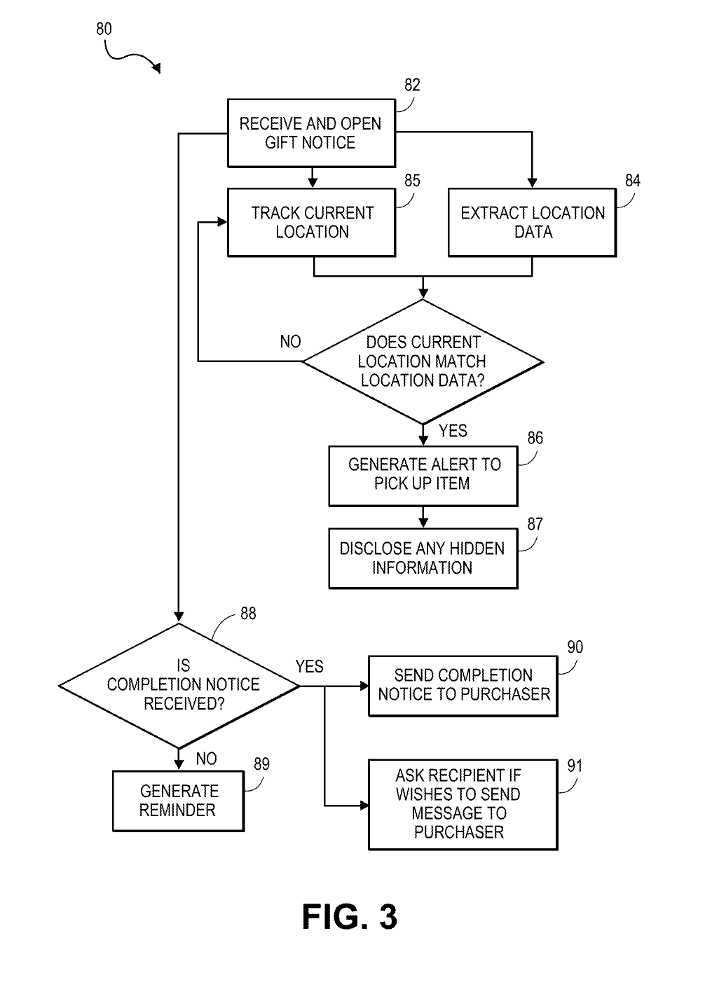

FIG. 3 is a flowchart depicting a gift retrieval process 80 that happens after the Gift Notice has been transmitted to the recipient's mobile device 10-r. Upon receiving a Gift Notice, the Notice may be “opened” by the user to view the content (step 82). This opening of the Gift Notice may entail a gesture, a swipe or tap on a touchscreen, or a voice command. The content that is disclosed at this point would be the “unhidden” content, which may include one or more of the following: the name of the item, an image, where it can be picked up (vendor address and location), business hours, identity of the sender, any personal content, and how much of the price remains to be paid.

In addition to the personal content and other information that is in the data package, the Gift Notice contains metadata such as the location data (such as the geo-tag data) and order number. When the Gift Notice is opened, the location data is automatically extracted and locally stored by the mobile device 10-r (step 84). The mobile device 10-r also tracks its current location continually or periodically at frequent intervals (step 85). The mobile device 10-r periodically checks to see if its current location matches the stored vendor location. If there is a location match, an alert is generated (step 86). The alert may be, for example, in the form of a visual and/or audio message such as “Stop by Hans' Bakery to pick up your Gift!”

In the situation where the purchaser hid some data during customization 70, the hidden data may be automatically revealed when the mobile device 10-r is close to the vendor location (step 87). Exactly how close the mobile device 10-r should be to the vendor location to trigger this unwrapping of the hidden information may be determined by the purchaser during the customization process 70. The disclosure or unwrapping of the hidden data will be triggered by a geographical/location-based event. As the unwrapping of the hidden information is automatically triggered by the proximity to the vendor location and only by such proximity in many cases, the recipient has to physically go to the prescribed location if s/he is curious about the gift.

When the recipient goes to the vendor to pick up the gift, the vendor may ask to see the Gift Notice to verify that the recipient indeed received a gift. A purchase code embedded in or accompanying the Gift Notice may be used by the vendor to identify the order, verify the payment amount, and check to see if any part of the purchase price remains to be paid. The purchase code may include an alphanumeric string, a QR code, bar code, or use of a near-field communication technology. When the gift is successfully picked up by the recipient, a notice is sent to the purchaser that the order has been completed. If the recipient paid for any part of the item, a receipt will be generated and sent to the recipient's mobile device 10-r.

When the gift is successfully picked up, the mobile device 10-r receives a Completion Notice indicating that the particular order has been fulfilled. The generation of the Completion Notice may be triggered by the recipient's activating a “Gift Retrieved” button or entering a code that is associated with the order that is provided by the vendor. After the Gift Notice is opened in step 82, the mobile device 10-r periodically checks to see if a Completion Notice has been generated for the particular order (step 88). If a Completion Notice is generated, the order is closed and a message is sent to the purchaser's mobile device 10-p letting the purchaser know that the gift has been picked up (step 90). An option may be presented to the recipient to send a reply message to the purchaser (step 91). The reply message may be in any of the formats that are allowed for the personal content in step 68.

If the Completion Notice has not been generated, the mobile device 10-r may wait a predefined amount of time and automatically generate a reminder to pick up the gift (step 89). Where a gift expires in 30 days, the automatic reminder may be scheduled to pop up after 10 days, 20 days, 25 days, and 29 days from the date the Gift Notice is opened.

When the recipient pays for any part of the item and receives a receipt (e.g., a digital receipt), the receipt may include a gift option that allows the recipient to instantly gift the same item to another recipient. If the recipient chooses to exercise the gift option, a Gift Notice will be transmitted to the next recipient and the same payment method that the first recipient previously used may be automatically used. This gift option is not limited to the recipient of the gift, but can be used by other purchasers. Anyone who receives an electronic receipt may be able to use the gift option that is included in the receipt.

The gift may have an expiration date. For example, if the gift is not picked up by the recipient within a window of time (e.g., 30 days, 60 days), it may automatically expire. Upon an expiration event, any paid amount will be returned to the purchaser and a notice of the returned payment will be sent to the purchaser along with an expiration notice.

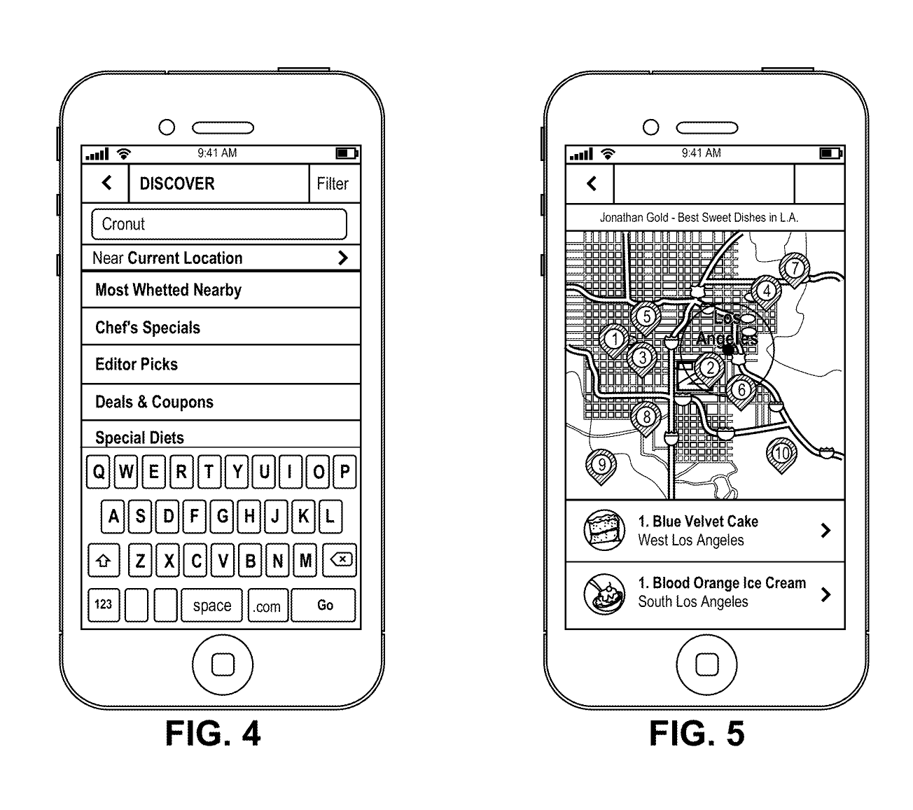

The gift giving process 50 will now be described in an example context where Bella just had an exchange with her friend Alexey about how she loves Cronuts, only to find out that Alexey has never had one. Walking home, Bella decides to buy a Cronut for Alexey so he can try it. Bella pulls out her mobile device 10-p and inputs the search term “Cronut” on a search page such as the one shown in FIG. 4. FIG. 4 depicts an example of a Search screen that Bella may use to make her purchase. In this example, the mobile device 10-p presents, in response to the search term “Cronut” entered at the top, a list of places that sell cronuts. Although not explicitly shown, Bella would be provided with a way to narrow the list, for example by distance (“within a 5-mile radius of my current location”) or by city or zip code. The search result may be presented in a list format such as in FIG. 4, or a map format such as in FIG. 5. If Bella happened to be passing by her favorite bakery when the thought of buying a cronut for Alexey occurred to her, she could have walked into the bakery and taken a photo of the cronut instead of using the Search function.

FIG. 5 depicts an example of a map-based search page that Bella may use. In response to the search term “Cronut,” a number of places/vendors that sell cronuts are identified. The identified places may be ranked 1-10, perhaps in order of proximity to Bella's current location. In response to Bella's selecting one of the markers on the map (for example, marker #3), information regarding the cronut(s) sold at the vendor may be presented (e.g., types, sizes, prices) along with an option to gift the item. The same page may allow Bella to view other items on the menu for that vendor. Browsing through the menu, Bella may stick with her original item choice of a cronut or change her mind and pick another item.

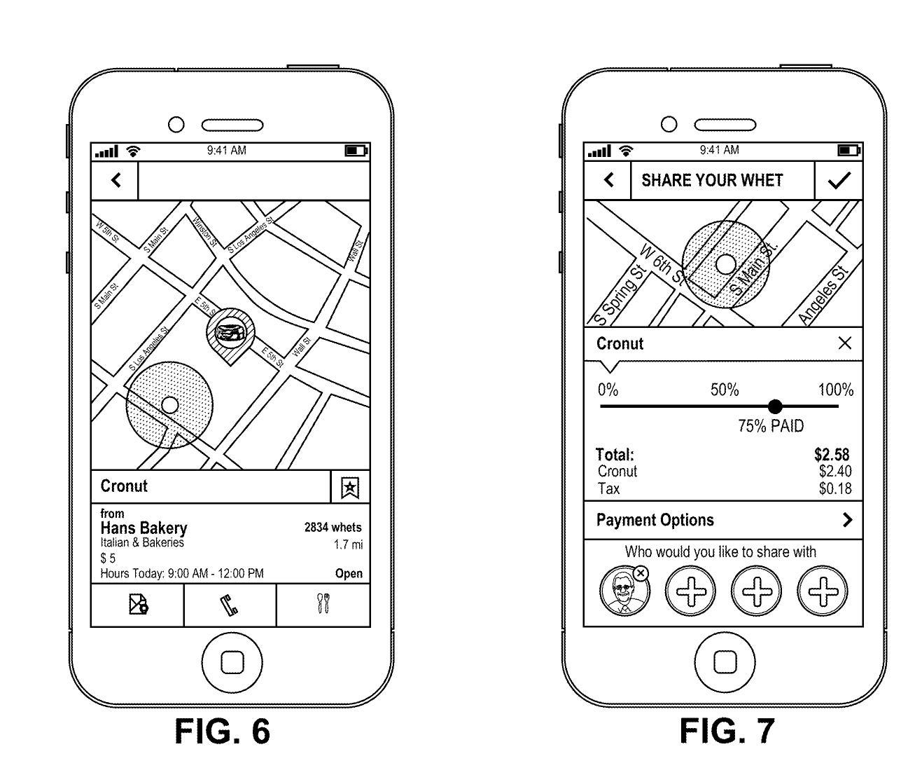

FIG. 6 depicts what is shown in response to Bella's making a selection, for example a Cronut from Hans' Bakery. The photo of a cronut is incorporated into a map marker and shown on the map. Other details about the location of the bakery, bakery hours, and distance from the current location may also be retrieved from the server 30 and shown so that Bella can make sure this item is what she wants.

FIG. 7 depicts an example of a payment interface Bella may be presented with to purchase the cronut. In this particular example, a slider is presented for Bella to choose what portion of the total price she wants to pay. She can then choose one of the payment options. Any known e-commerce payment methods may be used.

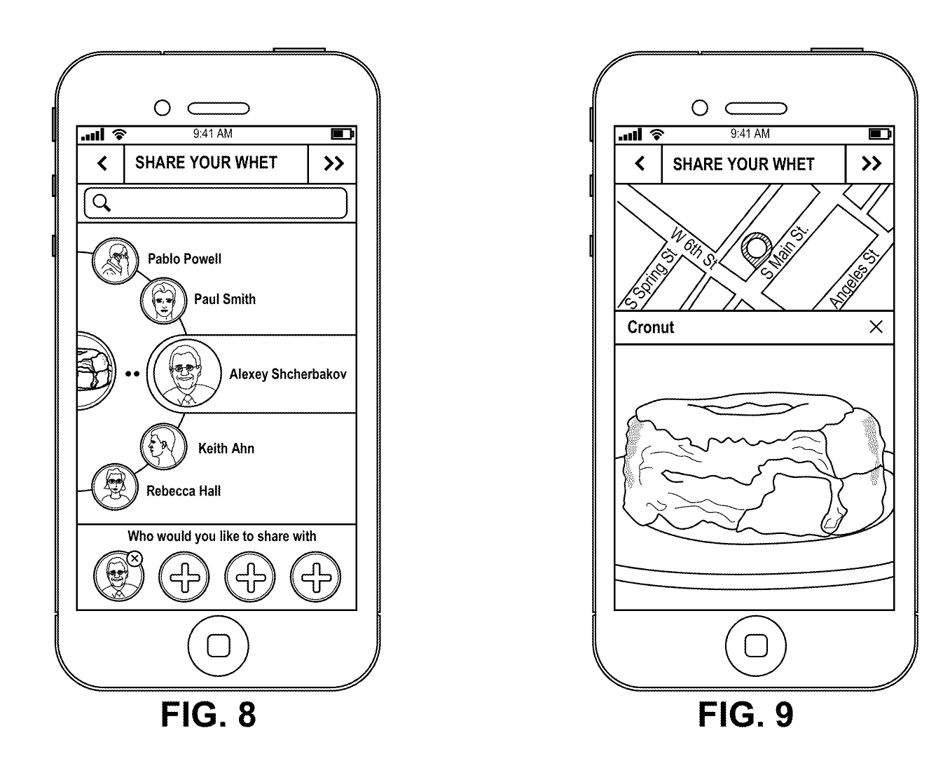

FIG. 8 depicts a list of names that may be presented as potential recipients of the cronut. In the example shown, Bella picks Alexey. Alexey's phone number and/or email address may be retrieved from device memory or, if unavailable, requested from Bella.

Having purchased a cronut for Alexey, Bella now adds personal content to the gift data package, as shown in step 68 of FIG. 2. FIG. 9 depicts a photograph of a cronut that Bella took with her mobile device 10-p or found via a Search. The photograph, which is associated with location data, will be packaged into the Gift Notice along with other personal content, unless Bella decides to “hide” it for later.

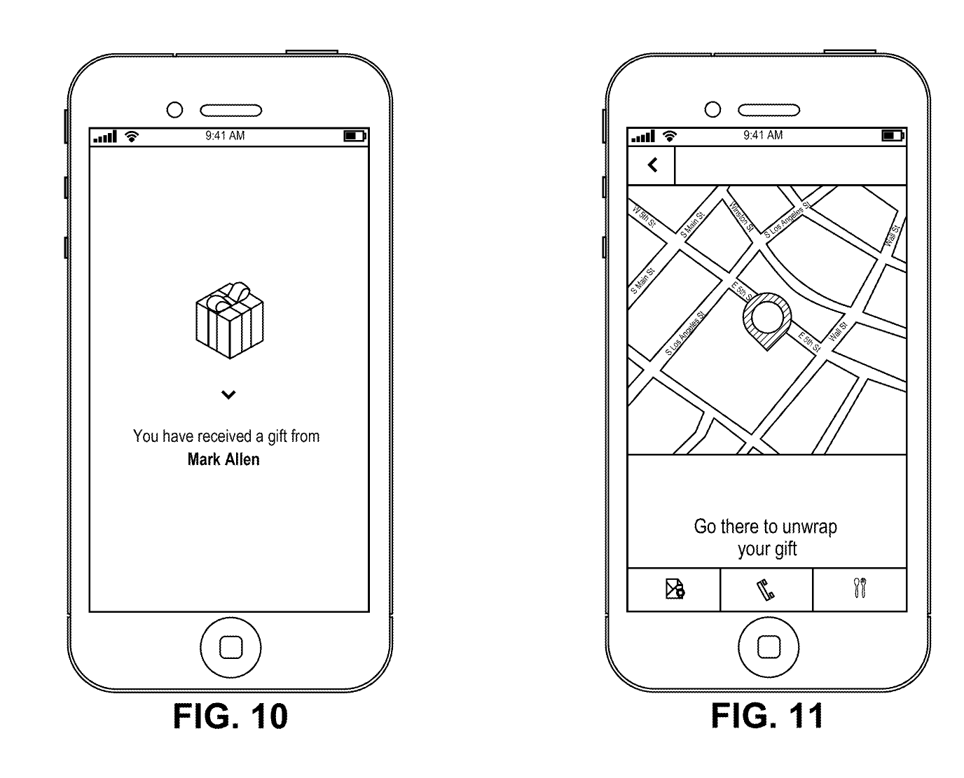

Before sending off the Gift Notice, Bella can also customize what information to reveal and what information to hide in the Gift Notice, as shown in step 70 of FIG. 2. Let's suppose, for example, that Bella decided to add a “surprise” element to the gift by hiding all information about the gift except the location where the gift can be picked up. Once the Gift Notice gets transmitted (step 72 of FIG. 2), Alexey receives the Gift Notice. FIG. 10 depicts an example of a Gift Notice that may pop up on Alexey's mobile device 10-r. When Alexey opens or activates the Gift Notice, for example by swiping across his touchscreen, he may get a screen that looks like what is depicted in FIG. 11. As shown, FIG. 11 simply shows a marker on a map with a question mark. In some embodiments, Alexey may be able to tap on the marker to obtain store hours and address. However, he will not be able to find out who the gift is from or what the gift is. To find out that information, Alexey has to physically go close to the location that is marked on the screen. Upon detecting proximity location match between the current location of the mobile device 10-r to and vendor location, the hidden data may be disclosed/unwrapped.

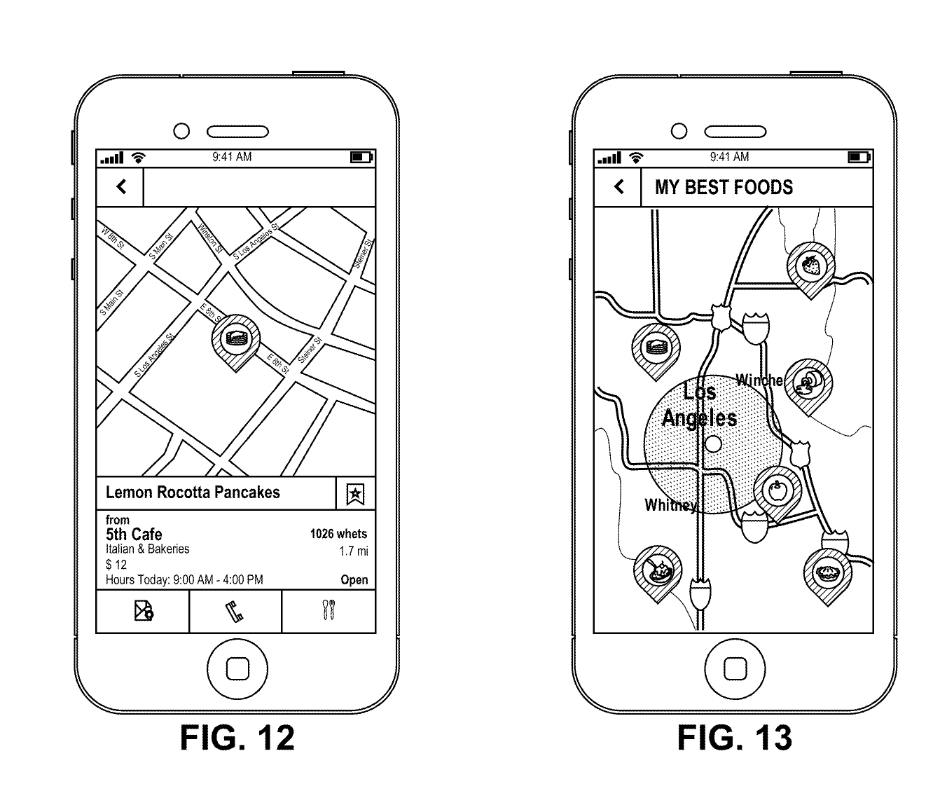

FIG. 12 depicts an example of a screen that may be presented to Alexey upon opening of the Gift Notice had Bella not chosen to hide any information during the customization process. In the example, an image of the gift item is included in the map marker that shows the location of where the gift can be picked up. The name of the item (Lemon Ricotta Pancakes), the vendor name, store hours, price, etc. may also be provided, as shown at the bottom of the screen in the example of FIG. 12.

FIG. 10 depicts an example of a Gift Notice that the gift recipient receives. As shown, the gift comes “wrapped” so that the recipient would have to activate/open the gift, for example by a gesture, touch, or click on the mobile device 10-r. Opening the gift will allow Alexey to see the information that the gift giver wanted to present to him at this stage. Any personal content, as well as what the item is, who it is from, where to pick it up, etc. may be presented to him upon activation, so he can go to Hans' Bakery and pick up his cronut. However, if the gift giver chose to hide some information, such as what the item is, the recipient would not see it at this stage.

The “hidden” information may automatically be revealed when the recipient goes to the vendor. For example, the GPS chip in the recipient's mobile device 10-r may sense that its current location matches (or is within a predetermined distance of) the vendor location data that is embedded in the Gift Notice. This location-based unwrapping of a portion of the gift information adds another dimension to the process of giving and receiving gifts.

It should be noted that the data in the data package can be presented in more than two layers described above (plain and hidden). For example, in some embodiments, the purchaser may want to add “hints” at different levels of proximity to the vendor location as personal content. In this case, the recipient would get one more piece of hidden information as s/he gets closer to the vendor location. When the recipient is 2 miles away from the vendor location, the mobile device 10-r, upon detecting this location match, may play Personal Content 1 that contains a first hint about what the mystery gift is. When the recipient is 1 mile away from the vendor location, the mobile device 10-4, upon detecting this location match, may play Personal Content 2 that contains a second hint about what the mystery gift is.

The gifting process 50 is not limited to one purchaser or one recipient. For example, a purchaser could purchase three items in a single transaction and select three recipients. As three separate Gift Notices will be generated and transmitted to the three recipients' mobile devices 10-r, the purchaser will receive separate notices about which gift has been picked up.

The purchaser may also add a competitive aspect to the gifting process by purchasing a number of items that does not match the number of recipients. For example, the purchaser may purchase three items for five recipients, and add a personal content saying that the gifts may be picked up on a first-come-first-serve basis. Once all the items have been picked up, a notice may be sent out to the recipients who did not pick up the gift that all the gifts have been claimed.

In some embodiments, the purchaser may have the option to ask some vendors to deliver the item to the recipient.

The mobile device 10 may be any portable electronic device that has a processor, a memory, a user interface unit, a location-detecting capability (e.g., a GPS chip), and wireless connectivity for receiving and transmitting data via a network. The user interface unit may be implemented with a visual interface (e.g., a Liquid Crystal Display or Organic Light Emitting Diode Display) with or without touch or gesture-sensing capability, a microphone and a speaker, a key board or keypad with hard keys and/or buttons, and a portable power source.

FIG. 13 is a screen showing previously geo-tagged items (in this case dishes). As mentioned above, the server 30 stores information about vendors, their locations, and the items they offer, as well as the number of times they've been tagged, etc. This database can be searched when someone wants to figure out what to buy or what to eat. In response to a search for “spaghetti and meatballs” filtered by a certain geographic range (e.g., “within two miles of my current location”), a screen such as what is shown in FIG. 13 may be presented.

Various embodiments of the present disclosure may be implemented in or involve one or more computer systems. All or some of the mobile device 10, the vendors 20, and the server 30 may include a computing system. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present disclosure, the memory may store software for implementing various embodiments of the present disclosure.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present disclosure, the storage may store instructions for the software implementing various embodiments of the present disclosure. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present disclosure, operating system software may provide an operating environment for software's executing in the computer system, and may coordinate activities of the components of the computer system.

Various embodiments of the inventive concept disclosed herein may be described in the general context of computer-readable media. Computer-readable media are any available media that may be accessed within a computer system. By way of example, and not limitation, within the computer system, computer-readable media include memory, storage, communication media, and combinations thereof

Having described and illustrated the principles of the inventive concept with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the inventive concept are described and illustrated herein, it will be appreciated that they are merely illustrative.

1. A computer-implemented method of providing data via a mobile device, comprising:
receiving a data package that includes location data and hidden data;
placing a marker on a position on a map that corresponds to the location data, wherein the marker indicates that there is hidden data that is discoverable at the physical location corresponding to the position on the map;
tracking current location; and
presenting the hidden data upon determining that the location data matches the current location.

2. The method of claim 1 further comprising storing the hidden data in a local memory until the location data matches the current location.

3. The method of claim 1, wherein the location data is determined to match the current location if the location data and the current location are within a predefined distance from each other.

4. The method of claim 1, wherein the data package further comprises at least one of an item name, a sender name, a vendor name, payment information, and personal content, wherein the personal content includes one or more of an image, a written message, an audio segment, and a video segment.

5. The method of claim 1, wherein the data package further comprises plain data that is presented in response to manual activation regardless of current location.

6. The method of claim 1, wherein the hidden data comprises a first set of hidden data and a second set of hidden data, and wherein the location data includes a first location and a second location, further comprising:
presenting the first set of hidden data when the current location matches the first location; and
presenting the second set of hidden data when the current location matches the second location.

7. The method of claim 1, wherein the location data is in the form of a geo-tag metadata associated with a vendor name that is included in the data package.

8. A computer-implemented method of transmitting a message, comprising:
receiving location data;
obtaining a recipient address;
receiving personal content that includes one or more of an image, a written message, an audio segment, and a video segment;
combining the location data with the personal content to create an electronic data package; and
transmitting the electronic data package to the recipient address.

9. The method of claim 8 further comprising:
receiving a request to hide part of the information in the electronic data package; and
configuring the part of the information that is requested to be hidden such that the hidden information is prevented from being presented upon opening of the electronic data package.

10. The method of claim 9 further comprising configuring the part of the information that is requested to be hidden such that the hidden information will be presented at a physical location that matches the location data.

11. The method of claim 8 further comprising:
receiving an item selection;
obtaining an item price for the selected item;
processing a payment for the selected item, wherein the payment is for less than the item price; and
configuring the electronic data package to include a request for an unpaid portion of the item price.

12. The method of claim 11, wherein processing the payment for the selected item comprises processing payments from multiple sources.

13. The method of claim 8, further comprising:
obtaining a plurality of recipient addresses including the recipient address; and
transmitting the electronic data package to the plurality of recipient addresses.

14. A non-transitory computer-readable storage medium storing executable computer program instructions for providing data via a mobile device, the computer program instructions comprising instructions for:
receiving a data package, wherein the data package includes location data and hidden data;
placing a marker on a position on a map that corresponds to the location data, wherein the marker indicates that there is hidden data that is discoverable at the physical location corresponding to the position on the map;
tracking current location; and
presenting the hidden data upon determining that the location data matches the current location.

15. The storage medium of claim 14, wherein computer program instructions further comprise instructions for storing the hidden data in a local memory until the location data matches the current location.

16. The storage medium of claim 14, wherein the location data is determined to match the current location if the location data and the current location are within a predefined distance from each other.

17. The storage medium of claim 14, wherein the data package further comprises at least one of an item name, a sender name, a vendor name, and personal content, wherein the personal content includes one or more of an image, a written message, an audio segment, and a video segment.

18. The storage medium of claim 14, wherein the data package further comprises plain data that is presented in response to manual activation regardless of current location.

19. A non-transitory computer-readable storage medium storing executable computer program instructions for providing data via a mobile device, the computer program instructions comprising instructions for:
receiving location data;
obtaining a recipient address;
receiving personal content that includes one or more of an image, a written message, an audio segment, and a video segment;
combining the location data with the personal content to create the electronic data package; and
transmitting the electronic data package to the recipient address.

20. The storage medium of claim 19, wherein the computer program instructions further comprise instructions for:
receiving a request to hide part of the information in the electronic data package; and
configuring the part of the information that is requested to be hidden such that the hidden information is prevented from being presented upon opening of the electronic data package.

21. The storage medium of claim 19, wherein the computer program instructions further comprise instructions for:
receiving an item selection;
obtaining an item price for the selected item;
processing a payment for the selected item, wherein the payment is for less than the item price; and
configuring the electronic data package to include a request for an unpaid portion of the item price.

22. A computer-implemented method of purchasing items for recipients, comprising:
receiving selections for a plurality of items;
receiving recipient addresses for a plurality of recipients; and
sending location data to the recipient addresses, the location data identifying one or more physical locations for retrieving the items.

23. The method of claim 22, wherein the number of items do not match the number of recipients.
